(19) United States
(12) Patent Application Publication
(10) Pub. No.: US 2013/0112311 A1
(43) Pub. Date: May 9, 2013

(54) FILLING ELEMENT, METHOD AND FILLING SYSTEM FOR FILLING CONTAINERS

(71) Applicants: Dieter-Rudolf Krulitsch, Bad Kreuznach (DE); Jonathan Lorenz, Bad Kreuznach (DE); Manfred Härtel, Bretzenheim (DE); Andreas Fahldieck, Idar-Oberstein (DE); Ludwig Clüsserath, Bad Kreuznach (DE)

(72) Inventors: Dieter-Rudolf Krulitsch, Bad Kreuznach (DE); Jonathan Lorenz, Bad Kreuznach (DE); Manfred Härtel, Bretzenheim (DE); Andreas Fahldieck, Idar-Oberstein (DE); Ludwig Clüsserath, Bad Kreuznach (DE)

(73) Assignee: KHS GmbH, Dortmund (DE)

(21) Appl. No.: 13/808,933

(22) PCT Filed: May 17, 2011
(86) PCT No.: PCT/EP2011/002424

§ 371 Date: Jan. 8, 2013

(30) Foreign Application Priority Data
Jul. 16, 2010 (DE) 10 2010 027 511.5

(51) Int. Cl. B67C 3/26

(52) U.S. Cl. CPC B67C 3/26
USPC 141/1; 141/311 R; 141/234

(57) ABSTRACT

A filling element for free jet filling of containers with a liquid charge includes a housing having a liquid channel formed therein, a liquid valve provided upstream of a dispensing opening, and an actuator device for actuating the liquid valve for controlled discharge of the liquid charge via the dispensing opening into a container arranged with a container opening thereof spaced below the dispensing opening. In an open state thereof, the liquid valve forms an opening gap through which the liquid charge flows. This opening gap has a gap width of at least four millimeters. The actuating device for the liquid valve is configured to cause the liquid valve to be in the open state for at least one hundred milliseconds.

The invention concerns a filling element for filling containers with a liquid charge in the form of a free jet according to the preamble of claim 1, a method according to the preamble of claim 8 and a filling system according to the preamble of claim 12.

Free jet filling in the sense of the invention means a method in which the liquid charge flows to the container to be filled in the form of a free jet of liquid, wherein the container with its container mouth or opening does not lie against the filling element but is spaced from the filling element or a dispensing opening thereof. An essential feature of this method is also that the air displaced from the container by the liquid product during the filling process does not enter the filling element or a gas-carrying region or channel formed therein but flows freely into the environment.

The opening gap in the sense of the invention is the gap which is formed in the region of the liquid valve when this valve is opened for the liquid charge and through which flows the liquid charge towards the at least one dispensing opening, emerging at the dispensing opening as a free jet of liquid charge.

The gap width in the sense of the invention is the width of the opening gap, preferably the minimum width of the respective opening gap for example when the opening gap has a different gap width along its gap course.

The opening time of the liquid valve in the sense of the invention is the time span required to fully open the closed liquid valve.

The opening speed of the liquid valve in the sense of the invention is the time-dependent change in opening or flow cross section of the opening gap on opening of the liquid valve.

Containers in the sense of the invention are general packaging means which are normally used for liquid and/or paste-like products, in particular drinks, for example soft packaging formed from flat material, containers of metal, gas and/or plastic, for example cans, bottles etc.

Filling elements or filling systems for free-jet filling of containers are known in themselves. A fundamental problem of such filling systems is that the penetration of ambient air through the at least one dispensing opening into the liquid channel (valve chamber) of the respective filling element must be prevented.

The penetration of ambient air into the liquid channel (valve chamber) must be prevented as resulting air bubbles in the charge first rise into the liquid channel and then into the product lines of the charge and finally into the boiler of the filling system or filling machine supplying the charge, amongst others with the risk of contamination and/or soiling of the charge in the product lines and in the boiler and/or with a loss of measurement accuracy of existing flow meters or measurement devices due to rising air bubbles.

In known filling elements or filling systems, the liquid valve concerned is opened by a corresponding actuating device quickly and completely i.e. with high opening speed and short opening times in the range between 50 and 100 milliseconds.

According to generally established opinion, the penetration of air into the liquid channel of the filling element concerned can only be prevented effectively if the gap width of the opening gap of the opened liquid valve is selected as small as possible, for example approximately 1.0 mm to 1.5 mm, and/or additionally a gas lock is provided or formed in the liquid channel which has a multiplicity of passages each with minimum flow cross section and prevents the penetration of ambient air and hence the formation of air bubbles rising in the filling element and in the product lines.

The known filling elements designed for free-jet filling (free-jet filling elements) and the known free-jet filling methods are unsuitable for filling product which also contains solid constituents, for example for fruit juices with fruit flesh and/or fruit fibres (pulp), since these products require gap sizes or gap widths for the opening gap of the open filling element of more than 3 mm, which in the known free-jet filling elements and systems would necessarily lead to the penetration of air bubbles into the liquid channel and via the product channels or lines into the product boiler.

The object of the invention is to develop a free-jet filling element which has an opening gap when the liquid valve is open with a gap width which allows free-jet filling also of products with solid constituents without the risk of penetration of ambient air into the liquid channel of the filling element and hence without the risk of air bubbles rising into the liquid channel of the filling elements and into the product lines, and which avoids the associated disadvantages.

This object is achieved by a filling element according to claim 1. A method and a filling machine are the subject of claims 8 and 12.

The invention is based on the knowledge that surprisingly, with an opening time substantially enlarged in relation to the opening times of known filling elements, prevention of the penetration of ambient air into the liquid channel of the filling element and hence the risk of rising air bubbles in the charge can be prevented.

Due to the relatively long opening time which is at least 100 ms (milliseconds) or to the resulting relatively slow opening speed, amongst others an excessive agitation of the charge within the liquid channel of the filling element and hence the inclusion of ambient air in the charge can be avoided.

It is furthermore ensured that the acceleration, which occurs on opening of the liquid valve, of the charge column in the filling element and in the product lines leading to the filling element, is sufficiently high.

The acceleration of the charge column present is sufficiently high if the flow cross section for the liquid charge resulting during the opening of the liquid valve—in particular also in the region of the opening gap occurring on opening of the liquid valve with the enlarged gap width in comparison with the opening gap of known filling elements—is filled completely and immediately with the charge and the charge flows through the flow cross section with sufficient flow speed so there is no chance of penetration of ambient air.

In a preferred embodiment of the invention the opening time of the liquid valve is greater than 100 ms but smaller than 1000 ms, preferably the opening time lies in the range between 400 ms and 600 ms. The gap width of the opening gap with the liquid valve completely opened is greater than 4 mm, for example greater than 8 mm but less than 20 mm, and is preferably 13 to 16 mm. The filling element according to the invention is designed without a gas lock.

In a preferred embodiment of the invention the liquid valve is opened such that the opening speed is not constant but only rises as opening increases, and is adapted to the acceleration behaviour of the product column present in the filling element or at the liquid valve so that always a full charge jet can be achieved which will safely avoid the penetration of air bubbles with minimum filling times. This adaptation of the opening speed is achieved for example by corresponding geometric design of the liquid valve or the valve body of the liquid valve and/or those segments of the liquid channel which hold this valve body at least at the start of the opening of the liquid valve, and/or by corresponding formation and/or control of an actuator device for the liquid valve or its valve body.

The term “substantially” in the sense of the invention includes deviations from the precise value concerned by +/−10%, preferably +/−5%, and/or deviations in the form of changes not significant for the function.

Refinements, advantages and possible applications of the invention arise from the description below of embodiment examples and from the figures. All features described and/or shown in diagrams in themselves or in any combination are in principle the subject of the invention irrespective of their summary in the claims or their back reference. Also the content of the claims is an integral part of the description.

The invention is described in more detail below with reference to the figures of an embodiment example. These show:

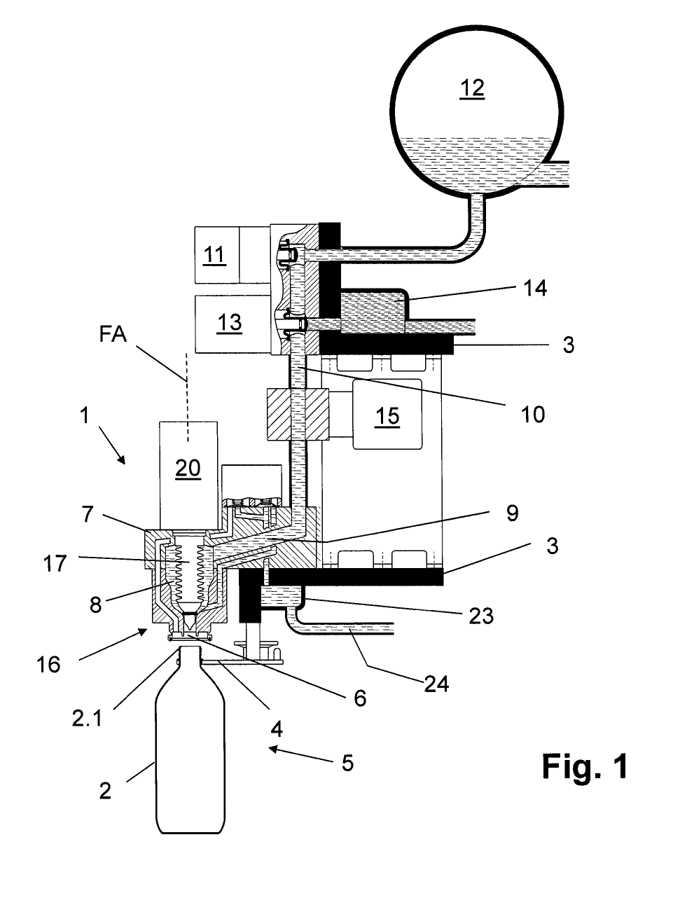

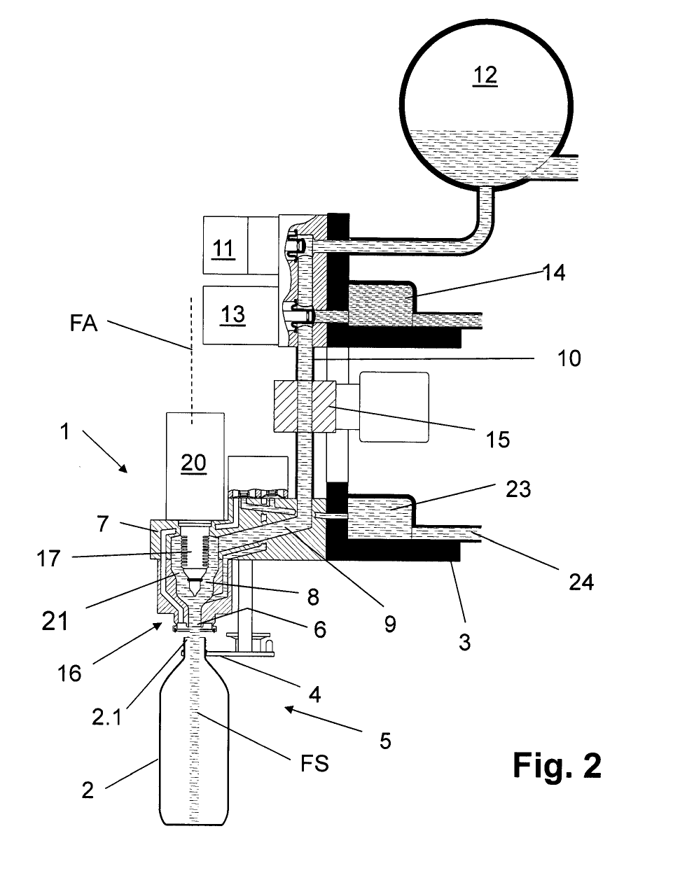

FIGS. 1 and 2 in simplified depiction and in cross section a filling element of a filling system or a filling machine for free-jet filling of containers in the form of bottles with a liquid charge which may also contain solid constituents, with the liquid valve closed (FIG. 1) and with the liquid valve open (FIG. 2);

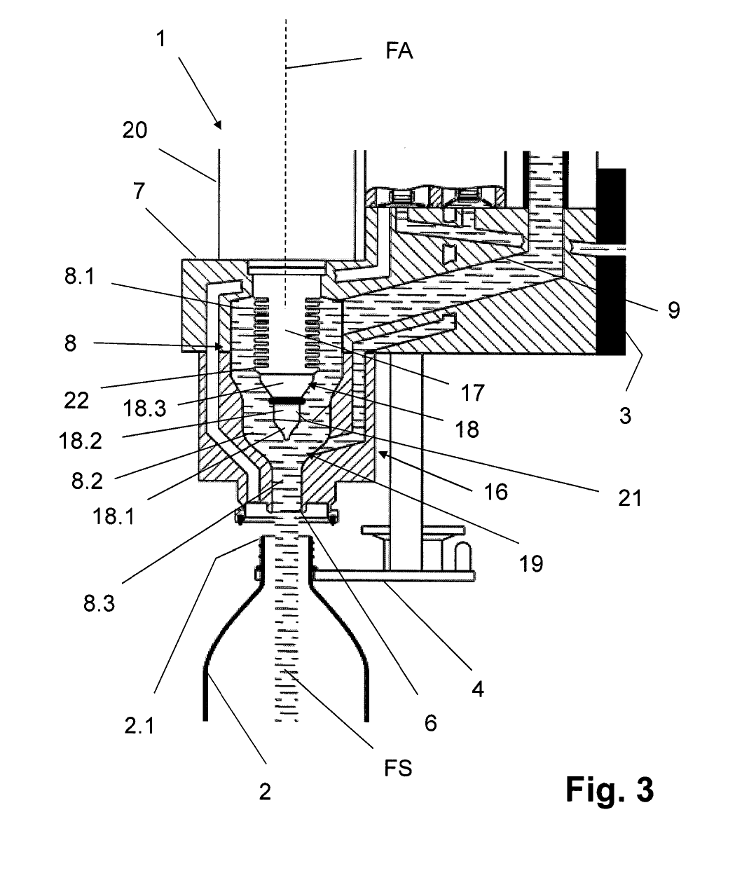

FIG. 3 in enlarged part view, the opened liquid valve.

In the FIGS. 1 is a filling element for free-jet filling of containers in the form of bottles 2 with a liquid charge, which in the embodiment shown consists of a first liquid component for example fruit juice and a second component containing more solid constituents for example fruit fibres and/or fruit flesh (pulp) and/or fruit pieces. The filling element 1 is arranged on the periphery of a rotor 3 that can be driven rotating around a vertical machine axis and together with a container carrier 4 forms a filling position 5 which is provided, together with a multiplicity of similar filling positions 5, on the periphery of rotor 3 and at which the respective bottle 2 is held during filling with a bottle or opening flange on container carrier 4 with its bottle opening 2.1 arranged spaced below the filling element 1 or below a dispensing opening 6 of the filling element 1 and suspended namely coaxial with its axis or substantially coaxial with a vertical filling element axis FA so that during filling the charge flows into the respective bottle 2 as a free charge jet FS.

In a housing 7 of the filling element 1 is formed a liquid channel 8 (valve chamber) which at the lower end has a dispensing opening 6 and at the upper end is connected via a product channel segment 9 with the lower end of a product channel 10 which is vertical in the embodiment shown. In the upper region this is connected via a metering valve 11 (liquid phase valve) to a boiler 12 which during the filling operation is partly filled with the first, more liquid component of the charge and via a metering valve 13 (solid phase valve) to a ring channel or ring boiler 14 which during filling operation is filled with the second component containing solid constituents in a higher concentration. The boiler 12 and ring channel or ring boiler 14 are provided common to all filling elements 1 of the filling machine on rotor 3.

In the product channel 10 is arranged a flow meter 15 which for example is an electromagnetic flow meter and supplies a signal corresponding to the respective flow quantity to a central control unit not shown, for example a computer-supported machine controller, which (measurement signal) achieves not only the mixing ratio of the two components corresponding to the recipe concerned by controlling the metering valves 11, 13, but also closure of the liquid valve 16 arranged in the liquid channel 8 namely after reaching the pre-specified quantity of product introduced into the respective bottle 2.

The liquid valve 16 essentially comprises a tappet 17 arranged coaxial with the filling element axis FA which at its lower end is formed as a valve body 18 with a valve body seal concentrically surrounding the filling element axis FA, wherein the latter to close the liquid valve cooperates with a valve surface which is formed on a cone surface 19 of the liquid channel 8 designed rotationally symmetrical to filling element axis FA.

To open and close the liquid valve 16, the valve tappet 17 with its valve body 18 is moved by an actuating device 20 in the filling element axis FA between the closed position shown in FIG. 1 in which the valve body 18 lies with its valve body seal against the valve face formed by the cone surface 19, and the opened position shown in FIGS. 2 and 3 in which the valve body or its seal is spaced from the cone surface, and between the valve body 18 and inner surface of the liquid channel 8 is formed a ring or opening gap 21 with a substantial gap width i.e. with a gap width greater than 4 mm, preferably with a gap width greater than 8 mm but less than 20 mm, preferably with a gap width between 13 mm to 16 mm. This allows problem-free filling of the bottles 2 with a mixed product comprising the first component from boiler 12 and the second component from ring channel 14.

As shown in detail in particular in FIG. 3, the valve tappet 18 in the embodiment shown is designed such that starting from the lower free end, it has first a preferably conical valve body segment 18.1 tapering towards this end, then a valve body segment 18.2 whose e.g. circular cylindrical outer cross section is the same as the largest outer cross section of the valve body segment 18.1, and following the valve body segment 18.2 a valve body segment 18.3 whose outer diameter increases upwards and which for example is formed frustoconical. All valve body segments 18.1-18.3 are arranged coaxial to each other and coaxial with axis FA.

Adjacent to the valve body segment 18.3 at the top, the valve tappet 17 is tightly surrounded by a bellows-like element 21 which acts as a seal sealing the passage of the valve tappet 17 through the filling element housing 7 but at the same time has an outer diameter which is the same or substantially the same as the maximum outer diameter of the valve body segment 18.3 so that at valve tappet 17 and at the valve body 18, flat segments and hence the flat segments facing away from the dispensing opening 16 are avoided so far that on opening the liquid valve 10, an agitation of the charge present in the liquid channel 8 and in particular a “suction effect” in the direction from the dispensing opening 6 into the liquid channel 8 are avoided.

In the embodiment shown the liquid channel 8 is designed so that it forms an upper, substantially circular cylindrical channel segment 18.1 into which opens the product line segment 9, then next to this downwards axially in relation to the filling element axis FA is an also substantially circular cylindrical channel segment 8.2 with a cross section reduced in relation to channel segment 8.1, then next to this a channel segment 8.3 with the cone surface 19 and tapering hopper-like in the direction towards the underside of filling element 1, followed by a channel segment 8.4 having the dispensing opening 6 and a circular cylindrical cross section. All channel segments 8.1-8.4 are arranged coaxial with each other and coaxial with axis FA. In the closed state of filling element 16 the valve body segment 18.1 is held largely in channel segment 8.4 and the valve body segment 8.3 largely in channel segment 18.3. On first opening of the liquid valve 16 the valve body segments 18.1 and 18.2 first move upward into the liquid channel segment 8.4. In fully opened state of liquid valve 16 the valve body 18 is held in the liquid channel segment 8.2 with the full gap width of the opening gap 21.

In order to avoid penetration of air bubbles into the liquid channel 8 on opening the liquid valve 16 despite the large opening width of the opening gap 21, the actuating device 20 is designed such that it causes an opening of the liquid valve with greatly reduced opening speed, or the opening speed here is greater than 100 ms, for example in the range between 100 ms and 1000 ms, preferably in the range between 400 ms and 600 ms. The effect achieved by the relatively slow opening of the liquid valve 16, namely the avoidance of the penetration of air bubbles in the liquid channel 8 despite the greater gap width of gap 21, is also supported in that at the valve tappet 17 and valve body 18 in the manner described above, an agitation of the product in the liquid channel 8 and/or flat areas causing a suction effect on opening the liquid valve 16 are avoided, and in particular in that on opening the liquid valve 16 the opening gap is only or substantially only formed after the valve body segment 18.2 emerges from the liquid channel segment 8.4 and is then enlarged slowly as long as the valve body segment 18.1 is still in the liquid channel segment 8.4. As the duration of the opening process increases, purely by the geometry of the liquid valve 16 this is opened increasingly but slowly until finally the maximum opening cross section or maximum gap width of the gap 21 formed between the valve body 18 and inner surface of the liquid channel 8 is reached. The opening speed of filling element 16 is here selected in any case so that the acceleration achieved, on opening, of the charge column occurring in liquid channel 8 is sufficient so that the additional flow or opening cross section which results from the increasing opening of liquid valve 16 is filled in each case directly and completely with the charge and this flows through the opening cross section with sufficient flow speed to avoid the penetration of air.

Evidently the possibility also exists of controlling the opening speed of the liquid valve 16 by corresponding control and/or design of an actuator device 20, in particular again in such a manner that the opening of the liquid valve 16 is adapted to the acceleration behaviour of the charge column present in the liquid channel 8 so that always a complete charge jet FS can be achieved, safely avoiding the penetration of air or air bubbles, with nonetheless a filling time as short as possible.

In the FIGS. 23 designates a ring channel common to all filling elements 1 of the filling machine on rotor 3, and 24 a product line, namely for a heating circuit to heat the charge or to maintain the charge in a hot condition.

The invention has been described above with one embodiment example. It is evident that numerous changes and derivations are possible without leaving the fundamental concept of the invention.

### REFERENCE NUMERAL LIST

1 Filling element

2 Bottle

2.1 Bottle opening

3 Rotor

4 Bottle or container carrier

5 Filling position

6 Dispensing opening

7 Filling element housing

8 Liquid channel in filling element housing 7

9 Product line segment

10 Product line

11 Metering valve

12 Boiler for first component

13 Metering valve

14 Ring channel or ring boiler for second component

15 Flow meter

16 Liquid valve

17 Valve tappet

18 Valve body

18.1-18.3 Valve body segment

19 Cone surface

20 Actuating element for valve tappet 17 and valve body 18

21 Opening gap

22 Bellows-like element

23 Ring channel for heat circulation

24 Line for heat circulation

FS Charge jet

FA Filling element axis

1-11. (canceled)

12. An apparatus comprising a filling element for free jet filling of containers with a liquid charge, said filling element comprising a filling element housing comprising a liquid channel formed therein, a liquid valve provided upstream of a dispensing opening, and an actuator device for actuating said liquid valve for controlled discharge of said liquid charge via said dispensing opening into a container arranged with a container opening thereof spaced below said dispensing opening, wherein, in an open state thereof, said liquid valve forms an opening gap through which said liquid charge flows, said opening gap having a gap width of at least four millimeters, and wherein said actuating device for said liquid valve is configured to cause said liquid valve to be in said open state for at least one hundred milliseconds.

13. The apparatus of claim 12, wherein said gap width is between eight millimeters and twenty millimeters.

14. The apparatus of claim 12, wherein said gap width is between thirteen millimeters and sixteen millimeters.

15. The apparatus of claim 12, wherein said actuating device is configured to cause said liquid valve to be in said open state for between one hundred milliseconds and one thousand milliseconds.

16. The apparatus of claim 12, wherein said actuating device is configured to cause said liquid valve to be in said open state for between four hundred milliseconds and six hundred milliseconds.

17. The apparatus of claim 12, wherein the liquid valve comprises a valve body comprising a valve body segment that, upon commencement of opening of said liquid valve, moves along a segment of said liquid channel, wherein said valve body segment and said liquid channel segment are configured to have a geometry such that said opening gap formed between said valve body segment and an inner face of said liquid channel segment on first opening of said liquid valve increases as said liquid valve is opened further, and wherein said liquid valve is configured according to at least one configuration selected from the group consisting of said liquid channel segment comprising an inner cross section that expands in a direction of opening movement of said valve body and said valve body segment comprising an outer cross section that reduces in response to said opening movement of said valve body.

18. The apparatus of claim 12, wherein said valve body comprises a valve tappet, and wherein said valve tappet has an outer diameter that is the same as a maximum outer diameter of said valve body.

19. The apparatus of claim 12, wherein said valve body comprises a valve tappet, and wherein an element surrounding said valve tappet has an outer diameter that is the same as a maximum outer diameter of said valve body.

20. The apparatus of claim 12, wherein said valve body comprises a valve tappet, and wherein a bellows-like element surrounding said valve tappet has an outer diameter that is the same as a maximum outer diameter of said valve body.

21. The apparatus of claim 12, wherein said liquid channel is designed without an element acting as a gas lock.

22. The apparatus of claim 12, further comprising a circulating filling machine comprising a rotor for supporting a multiplicity of filling elements, including said filling element, said rotor being configured to be driven about a vertical machine axis.

23. A method for free-jet filling of a container with liquid charge, said method comprising providing a filling element housing comprising a liquid channel formed therein, providing a liquid valve upstream of a dispensing opening, arranging a container so that a container opening thereof is spaced below said dispensing opening, providing an actuator device for actuating said liquid valve for controlled discharge of said liquid charge via said dispensing opening into said container, causing said liquid valve to transition into an open state during which said liquid valve forms an opening gap through which said liquid charge flows, said opening gap being at least four millimeters wide, and causing said liquid valve to be in said open state for longer than one hundred milliseconds.

24. The method of claim 23, wherein causing said liquid valve to transition into an open state comprises causing said opening gap to be between eight millimeters and twenty millimeters wide.

25. The method of claim 23, wherein causing said liquid valve to transition into an open state comprises causing said opening to be between thirteen millimeters and sixteen millimeters wide.

26. The method of claim 23, wherein causing liquid valve to be in said open state comprises causing said liquid valve to be in said open state for between one hundred milliseconds and one thousand milliseconds.

27. The method of claim 23, wherein causing said liquid valve to be in said open state comprises causing said liquid valve to be in said open state for between four hundred milliseconds and six hundred milliseconds.
